(19) United States
(12) Patent Application Publication
(10) Pub. No.: US 2020/0348566 A1
(43) Pub. Date: Nov. 5, 2020

(54) LIGHT BUNDLE CONTROL MEMBER, LIGHT EMITTING DEVICE, AREA-LIGHT SOURCE DEVICE, AND DISPLAY DEVICE

(71) Applicant: Enplas Corporation, Saitama (JP)

(72) Inventor: Toshihiko MOCHIDA, Saitama (JP)

(73) Assignee: Enplas Corporation, Saitama (JP)

(21) Appl. No.: 16/760,048

(22) PCT Filed: Oct. 23, 2018
(86) PCT No.: PCT/JP2018/039379

§ 371 Date: Apr. 29, 2020

(30) Foreign Application Priority Data
Nov. 2, 2017 (JP) 2017-212787

(51) Int. Cl. G02F 1/13357

(52) U.S. Cl. CPC G02F 1/133606; G02F 2001/133607; G02F 1/133603

(57) ABSTRACT

This light bundle control member comprises an incident surface, an exit surface, a plurality of grooves, and a plurality of ridges. At least one of the incident surface and the exit surface has an elliptical cross section perpendicular to a central axis of the light bundle control member. The grooves are arranged on the back side of the light bundle control member successively from the central axis side toward the outer edge side of the light bundle control member. Each of the grooves includes a step surface positioned on the central axis side, and an inclined surface positioned on the outer edge side. The ridges are respectively arranged on the inclined surface of each of the grooves. Each of the ridges includes a first reflecting surface, a second reflecting surface, and a ridge line arranged between the first reflecting surface and the second reflecting surface.

### TECHNICAL FIELD

The present invention relates to a light flux controlling member that controls a distribution of light emitted from a light emitting element, and to a light emitting device, a surface light source device and a display device including the light flux controlling member.

### BACKGROUND ART

Some transmitting image display devices such as liquid crystal display devices use a direct surface light source device as a backlight. In recent years, a direct surface light source device including a plurality of light emitting elements as the light source have been used.

For example, a direct surface light source device includes a substrate, a plurality of light emitting elements (e.g., white light emitting diodes), a plurality of light flux controlling members (lenses), and a light diffusion plate. The light emitting elements are disposed at predetermined positions on the substrate. The light flux controlling member that expands the light of the light emitting element in the plane direction of the substrate is disposed over each light emitting element. The light emitted from the light flux controlling member is expanded by the light diffusion plate so as to illuminate an irradiation target member (e.g., a liquid crystal panel).

FIGS. 1A and 1B illustrate a configuration of a conventional light flux controlling member. FIG. 1A is a perspective view as viewed from a rear side, FIG. 1B is a perspective view illustrating a cross-section as viewed from a rear side, and FIG. 1C is a sectional view. Note that, in FIGS. 1A and 1B, three legs disposed on the rear side are omitted. As illustrated in FIGS. 1A to 1C, conventional light flux controlling member 20 includes incidence surface 22 and emission surface 24. Incidence surface 22 is the inner surface of a recess formed on the rear side (light emitting element side), and allows incidence of light emitted from the light emitting element. Emission surface 24 is disposed on the front side (light diffusion plate side), and emits, to the outside, light entered from incidence surface 22.

FIGS. 2A and 2B are light path diagrams of light flux controlling member 20. FIG. 2A is a light path diagram of light beams emitted from a center of the light emission surface of light emitting element 10 at an emission angle of 30°, and FIG. 2B is a light path diagram of light beams emitted from a center of the light emission surface of light emitting element 10. Here, the “emission angle” is an angle (θ in FIG. 2A) of a light beam to optical axis OA of light emitting element 10. Note that, in FIGS. 2A and 2B, three legs disposed on the rear side are omitted.

As illustrated in FIGS. 2A and 2B, light emitted from light emitting element 10 enters light flux controlling member 20 from incidence surface 22. The light entered light flux controlling member 20 reaches emission surface 24. The majority of the light having reached emission surface 24 is emitted to the outside from emission surface 24 (solid line arrow). At this time, the light emitted from emission surface 24 is refracted at emission surface 24 such that the travelling direction is controlled. The other part of the light having reached emission surface 24 is reflected (Fresnel reflection) by emission surface 24, and reaches rear surface 26 (broken line arrow). A part of the light having reached rear surface 26 is internally reflected by rear surface 26, and is emitted from emission surface 24 toward a part immediately above light flux controlling member 20. When the quantity of the light travelling toward the part immediately above light flux controlling member 20 in the above-mentioned manner, the region around light flux controlling member 20 in the light emitting surface (light diffusion plate) is excessively brightened, and luminance unevenness is caused. The other part of the light having reached rear surface 26 passes through light rear surface 26. A part of the light having passed through rear surface 26 in the above-mentioned manner is absorbed by the substrate, and consequently the light use efficiency is reduced. The other part of the light having passed through rear surface 26 is reflected by the substrate and becomes uncontrollable light. In view of this, PTL 1 proposes a light flux controlling member for solving the above-mentioned problems.

FIGS. 3A to 3C illustrate a configuration of light flux controlling member 30 disclosed in PTL 1. FIG. 3A is a perspective view as viewed from a rear side, FIG. 3B is a perspective view illustrating a cross section as viewed from a rear side, and FIG. 3C is a sectional view. Note that, in FIGS. 3A and 3B, three legs disposed on the rear side are omitted. As illustrated in FIGS. 3A to 3C, in light flux controlling member 30 disclosed in PTL 1, a groove including inclined surface 32 located on the outside and perpendicular surface 34 located on the inside that is approximately parallel with central axis CA is formed in rear surface 26. Inclined surface 32 is rotationally symmetrical (circularly symmetrical) about central axis CA of light flux controlling member 30, and is tilted at a predetermined angle (e.g., 45°) with respect to a virtual straight-line orthogonal to central axis CA.

FIGS. 4A and 4B are light path diagrams of light flux controlling member 30. FIG. 4A is a light path diagram of light beams emitted from a center of the light emission surface of light emitting element 10 at an emission angle of 30°, and FIG. 4B is a light path diagram of light beams emitted from a center of the light emission surface of light emitting element 10. Note that, also in FIGS. 4A and 4B, three legs disposed on the rear side are omitted. As illustrated in FIGS. 4A and 4B, light internally reflected by emission surface 24 reaches a predetermined region of rear surface 26. With inclined surface 32 formed at the predetermined region, at least a part of the light having reached inclined surface 32 can be reflected toward the lateral direction.

In this manner, in light flux controlling member 30 disclosed in PTL 1, light internally reflected at emission surface 24 is not easily directed toward the part immediately above light flux controlling member 30, and is not easily absorbed by the substrate. Accordingly, the light emitting device having light flux controlling member 30 disclosed in PTL 1 can uniformly and efficiently emit light in comparison with a conventional light emitting device having light flux controlling member 20.

In addition, in recent years, LEDs of chip-on-board (COB) type have been used as the light source of illumination devices because of its ease of mounting, and its high light emission efficiency. The LEDs of COB type are known to emit a larger quantity of light also in the lateral direction in addition to the light emission in the upward direction, in comparison with conventional LEDs.

### CITATION LIST

### Patent Literature

PTL 1

Japanese Patent Application Laid-Open No. 2009-43628

### SUMMARY OF INVENTION

### Technical Problem

In the case where an LED of COB type is used as a light emitting element of the surface light source device disclosed in PTL 1, light flux controlling member 30 may be disposed such that rear surface 26 is lower than the top surface of the LED for the purpose of controlling the light such that a large quantity of the light emitted in the lateral direction of the LED enters light flux controlling member 30 from incidence surface 22. At this time, light having been emitted from the LED in the lateral direction and having entered light flux controlling member 30 from a lower portion of incidence surface 22 reaches perpendicular surface 34 of the groove. This light passes through perpendicular surface 34, or is scattered depending on the state of perpendicular surface 34. Further, the majority of the light having passed through perpendicular surface 34 is refracted by inclined surface 32 toward the part immediately upward of light flux controlling member 30 (see FIG. 5). In the above-described manner, in the case where an LED of COB type is used for the surface light source device disclosed in PTL 1, the scattering at perpendicular surface 34 and the refraction at inclined surface 32 result in an excessive quantity of the light travelling toward the part immediately upward of light flux controlling member 30 and formation of a circular bright region in a region around the upper part of light flux controlling member 30, and consequently luminance unevenness is caused. Also, in the case where rear surface 26 of light flux controlling member 30 is disposed on the upper side of the top surface of the LED, light entered from a portion near the outer edge of the recess composed of incidence surface 22 may possibly reach perpendicular surface 34 of the groove through refraction.

An object of the present invention is to provide a light flux controlling member that less causes luminance unevenness of light emitted from the light flux controlling member even when used in combination with a light emitting element, such as an LED of COB type, that emits light more in the lateral direction.

In addition, another object of the present invention is to provide a light emitting device, a surface light source device and a display device including the light flux controlling member.

### Solution to Problem

A light flux controlling member according to an embodiment of the present invention is configured to control a distribution of light emitted from a light emitting element, the light flux controlling member including: an incidence surface that is an inner surface of a recess disposed on a rear side of the light flux controlling member, the recess being disposed to intersect a central axis of the light flux controlling member, the incidence surface being configured to allow incidence of the light emitted from the light emitting element; an emission surface disposed on a front side of the light flux controlling member to intersect the central axis, the emission surface being configured to emit, to outside, light entered from the incidence surface; a plurality of grooves sequentially disposed in a direction toward an outer edge side of the light flux controlling member from a central axis side on the rear side of the light flux controlling member, each of the plurality of grooves including a step surface located on the central axis side and an inclined surface located on the outer edge side; and a plurality of ridges disposed in the inclined surface of each of the plurality of grooves, each of the plurality of ridges including a first reflection surface, a second reflection surface, and a ridgeline disposed between the first reflection surface and the second reflection surface. At least one of the incidence surface and the emission surface has a shape of an ellipse in a cross-section perpendicular to the central axis. When the incidence surface has the shape of the ellipse in the cross-section, at least one of the plurality of ridges is disposed in the inclined surface located outside the recess in a direction of a minor axis of the ellipse. When the emission surface has the shape of the ellipse in the cross-section, at least one of the plurality of ridges is disposed in the inclined surface located outside the recess in a direction of a longitudinal axis of the ellipse.

A light emitting device according to an embodiment of the present invention includes a light emitting element; and the above-mentioned light flux controlling member, the light flux controlling member being disposed over the light emitting element.

A surface light source device according to an embodiment of the present invention includes the above-mentioned light emitting device; and a light diffusion plate configured to allow light emitted from the light emitting device to pass through the light diffusion plate while diffusing the light.

A display device according to an embodiment of the present invention includes the above-mentioned surface light source device; and a display member configured to be irradiated with light emitted from the surface light source device.

### Advantageous Effects of Invention

The light flux controlling member according to an embodiment of the present invention causes less luminance unevenness of emission light even when used with a light emitting element, such as an LED of COB type, that emits a large quantity of light in the lateral direction.

In addition, the light emitting device, the surface light source device and the display device according to an embodiment of the present invention cause less luminance unevenness emission light since they include the above-mentioned light flux controlling member that causes less luminance unevenness.

### BRIEF DESCRIPTION OF DRAWINGS

FIGS. 1A to 1C illustrate a configuration of a conventional light flux controlling member;

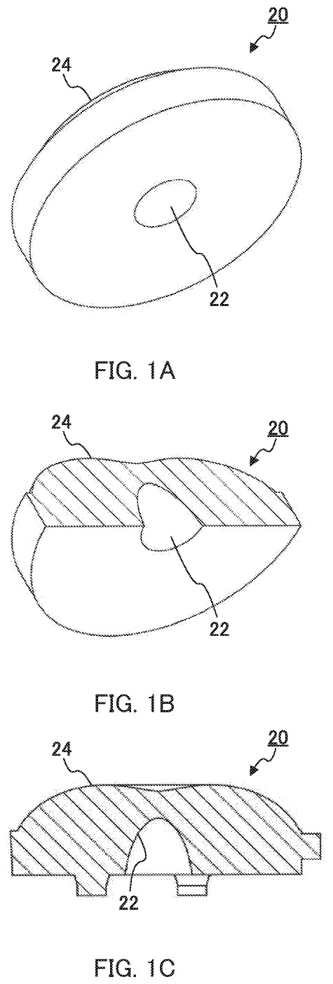

FIGS. 2A and 2B are light path diagrams of a conventional light flux controlling member;

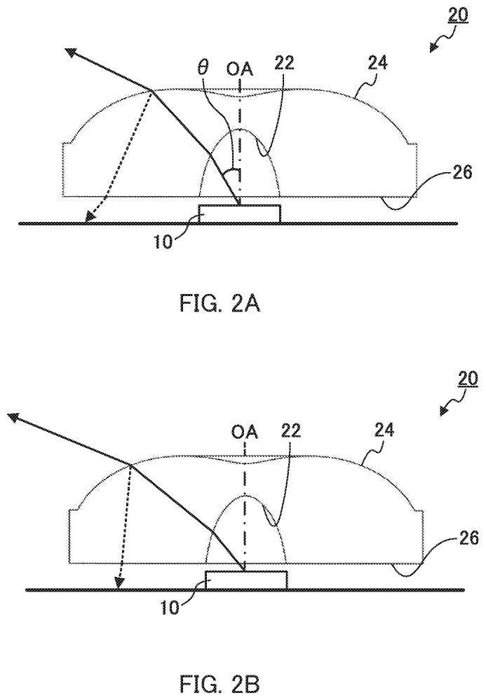

FIGS. 3A to 3C illustrate a configuration of a light flux controlling member disclosed in PTL 1;

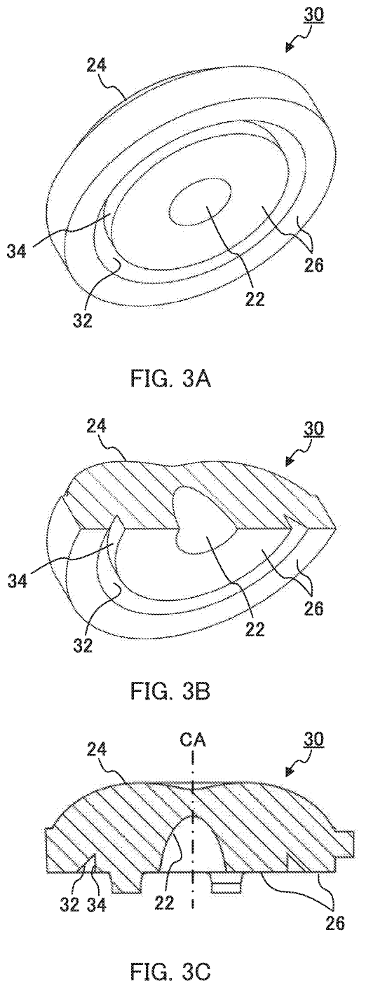

FIGS. 4A and 4B are light path diagrams of the light flux controlling member disclosed in PTL 1;

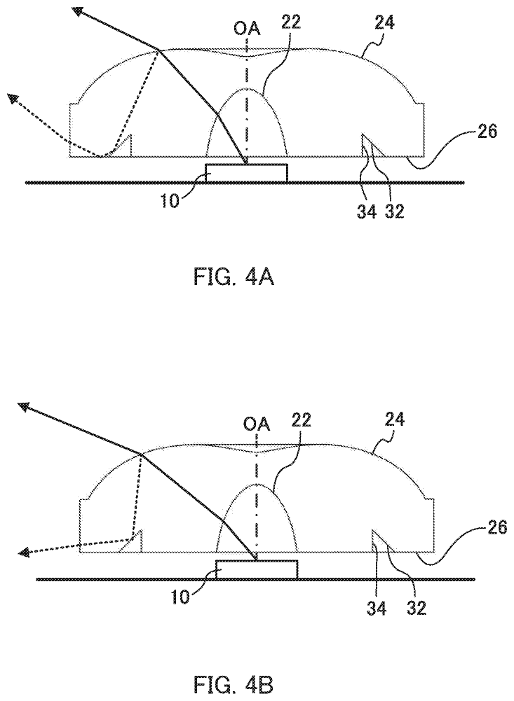

FIG. 5 is another light path diagram of the light flux controlling member disclosed in PTL 1;

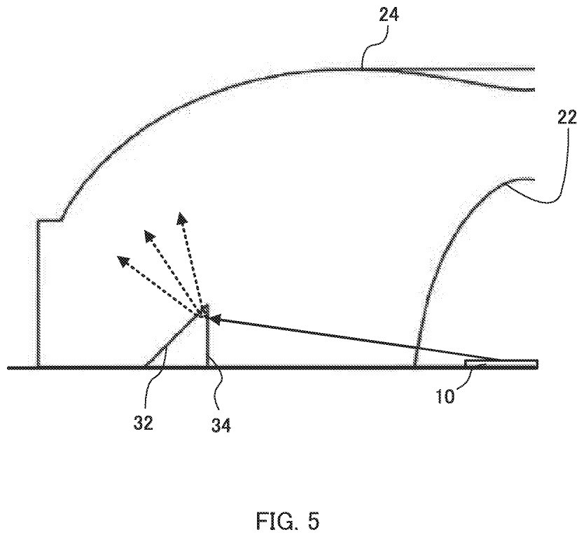

FIGS. 6A and 6B illustrate a configuration of a surface light source device according to Embodiment 1;

FIGS. 7A and 7B are sectional views illustrating a configuration of the surface light source device according to Embodiment 1;

FIG. 8 is a partially enlarged sectional view of the surface light source device according to Embodiment 1;

FIG. 9 is a perspective view of a light flux controlling member according to Embodiment 1 as viewed from a rear side;

FIGS. 10A to 10E illustrate a configuration of the light flux controlling member according to Embodiment 1;

FIG. 11A is a sectional view illustrating light paths in a comparative light flux controlling member, and FIG. 11B is a sectional view illustrating light paths in the light flux controlling member according to the embodiment;

FIG. 12A is a sectional view illustrating light paths in a comparative light flux controlling member, and FIG. 12B is a sectional view illustrating light paths in the light flux controlling member according to the embodiment;

FIG. 13 is a graph illustrating the quantity of light that passes through the light flux controlling member and reaches a rear surface of a substrate;

FIG. 14 is a perspective view of a light flux controlling member according to Embodiment 2 as viewed from the rear side; and

FIGS. 15A to 15D illustrate a configuration of the light flux controlling member according to Embodiment 2.

### DESCRIPTION OF EMBODIMENTS

A light flux controlling member, a light emitting device, a surface light source device and a display device according to embodiments are described below with reference to the accompanying drawings. In the following description, a surface light source device suitable for a backlight of a liquid crystal display apparatus and the like is described as a typical example of the surface light source device according to the embodiments.

### Embodiment 1

### Configuration of Surface Light Source Device and Light Emitting Device

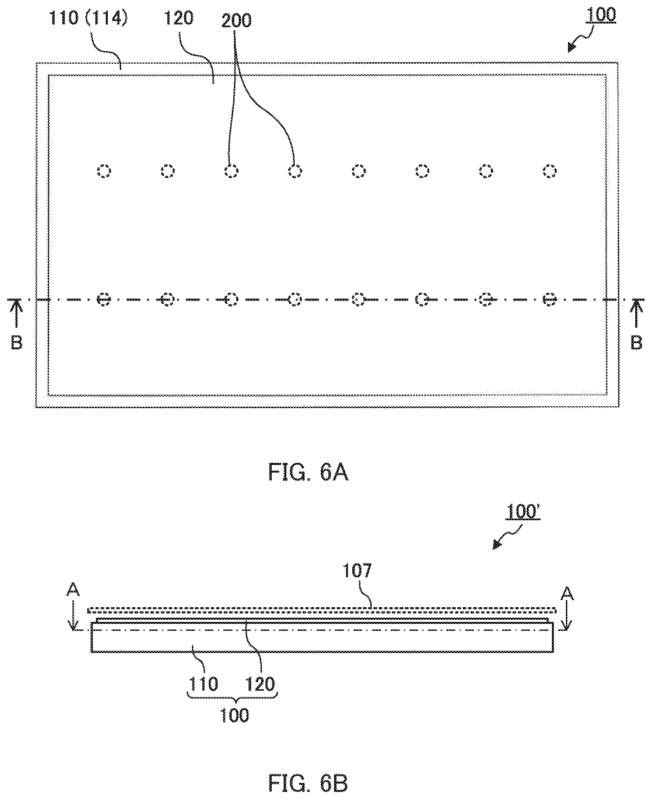

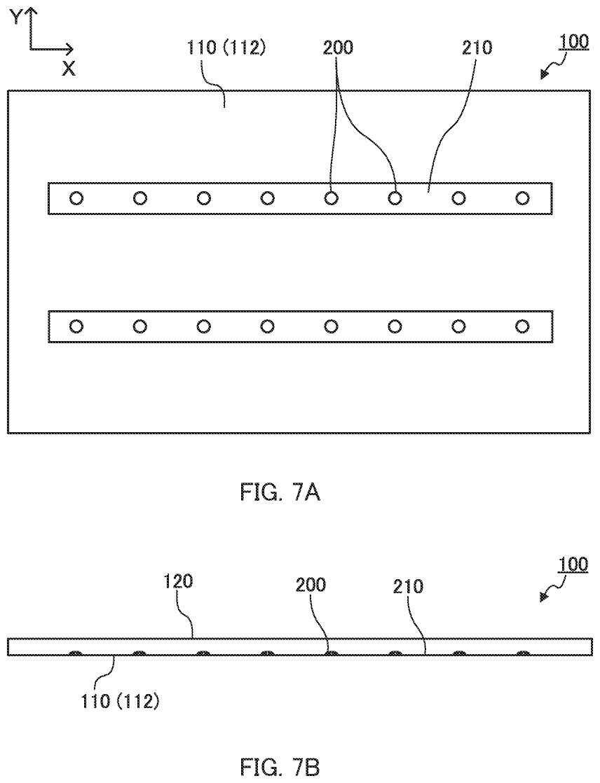

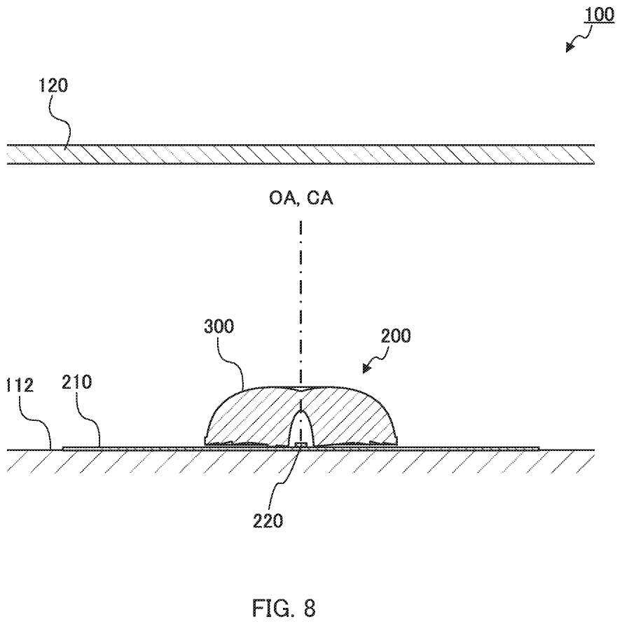

FIGS. 6A to 8 illustrate a configuration of surface light source device 100 according to Embodiment 1. FIG. 6A is a plan view of surface light source device 100 according to Embodiment 1, and FIG. 6B is a front view of surface light source device 100. FIG. 7A is a sectional view taken along line A-A of FIG. 6B, and FIG. 7B is a sectional view taken along line B-B of FIG. 6A. FIG. 8 is a partially enlarged sectional view of surface light source device 100.

As illustrated in FIGS. 6A to 8, surface light source device 100 includes housing 110, a plurality of light emitting devices 200, and light diffusion plate 120. Surface light source device 100 according to the present embodiment is applicable to a backlight of a liquid crystal display apparatus. In addition, as illustrated in FIG. 6B, surface light source device 100 can be used as display device 100′ when combined with a display member (illumination target member) 107 (indicated with dotted line in FIG. 6B) such as a liquid crystal panel.

Light emitting devices 200 are disposed in a matrix or in a line on bottom plate 112 of housing 110. The inner surface of bottom plate 112 functions as a diffusive reflection surface. In addition, top plate 114 of casing 110 is provided with an opening. Light diffusion plate 120 is disposed to cover the opening, and functions as a light emitting surface. The light emitting surface may have a size of, for example, approximately 400 mm×approximately 700 mm.

The ratio of the center-to-center distance (pitch) of light emitting devices 200 in a first direction (the X direction illustrated in FIG. 7A) to the center-to-center distance (pitch) of light emitting devices 200 in a second direction (the Y direction illustrated in FIG. 7A) orthogonal to the first direction in the case where light emitting devices 200 are disposed in a matrix is about 1:4, for example. In the present embodiment, even when the pitch of light emitting devices 200 in the first direction and the pitch of light emitting devices in the second direction differ from each other as described above, the irradiation target member can be uniformly illuminated. In the case where the pitch in the first direction and the pitch in the second direction differ from each other, it is preferable that the region to be irradiated by light emitting device 200 have a substantially elliptical shape. In this case, it is preferable that the longitudinal axis of the ellipse extend along one of the first direction and the second direction that has a larger pitch than the other. In the case where a plurality of light emitting devices 200 are disposed on bottom plate 112 of housing 110 in a line, and the distance between the inner surface (the inner surface of the side plate) of housing 110 and the center of light emitting device 200 in the direction orthogonal to the line of light emitting devices 200 is greater than the distance between adjacent light emitting devices 200, it is preferable that the longitudinal axis of the ellipse be aligned along the direction orthogonal to the line of the light emitting devices 200.

Each light emitting device 200 is fixed at a predetermined position on bottom plate 112 of housing 110. As illustrated in FIG. 8, normally, light emitting devices 200 are fixed on substrate 210 fixed on bottom plate 112 of housing 110. Each light emitting device 200 includes light emitting element 220, and light flux controlling member 300.

Substrate 210 is a plate-shaped member that supports light emitting element 220 and light flux controlling member 300. Substrate 210 is fixed on bottom plate 112.

Light emitting element 220 is the light source of surface light source device 100, and is disposed on substrate 210. Light emitting element 220 is a light emitting diode (LED) such as a white light emitting diode, for example. Preferably, in the present embodiment, light emitting element 220 is an LED of chip-on-board (COB) type from the viewpoint of the ease of mounting and high light emission efficiency. It is known that an LED of COB type emits a larger quantity of light in the lateral direction than a conventional LED. Light emitting element 220 that is an LED of COB type or the like emits a large quantity of light in the lateral direction, and therefore it is necessary that a larger quantity of light emitted from light emitting element 220 in the lateral direction enter light flux controlling member 300. Therefore, it is preferable to dispose light emitting element 220 such that the top surface thereof is located on the front side (light diffusion plate 120 side) relative to the lower end (opening edge) of a recess composed of incidence surface 310 described later.

Light flux controlling member 300 is fixed on substrate 210 in such a manner as to cover light emitting element 220. Light flux controlling member 300 controls the distribution of light emitted from light emitting element 220, and expands the light travelling direction in the plane direction of substrate 210. Light flux controlling member 300 is disposed over light emitting element 220 in such a manner that its central axis CA is aligned with optical axis OA of light emitting element 220 (see FIG. 8). Note that, “central axis CA of light flux controlling member 300” is a straight line that is a rotation center of light flux controlling member 300. Light flux controlling member 300 according to the present embodiment is rotationally symmetrical (two-fold rotationally symmetrical; the leg is not taken into consideration). In addition, “optical axis OA of light emitting element” means a central light beam of a stereoscopic light flux from light emitting element 220.

Light flux controlling member 300 can be formed by integral molding. The material of light flux controlling member 300 is not limited as long as light of a desired wavelength can pass therethrough. For example, the material of light flux controlling member 100 is an optically transparent resin such as polymethylmethacrylate (PMMA), polycarbonate (PC), epoxy resin (EP) and silicone resin, or glass. A main feature of surface light source device 100 according to the present embodiment is the configuration of light flux controlling member 300. Therefore, light flux controlling member 300 will be separately described in detail.

Light diffusion plate 120 is a plate-shaped member having a light diffusing property, and allows the light emitted from light emitting device 200 to pass therethrough while diffusing the light. Light diffusion plate 120 is disposed over light emitting devices 200 with an air layer therebetween in such a manner that light diffusion plate 120 is approximately parallel to substrate 210. Light diffusion plate 120 is disposed over light emitting devices 200 with an air layer therebetween in such a manner that light diffusion plate 120 is approximately parallel to substrate 210. Normally, the size of light diffusion plate 120 is substantially the same as that of the illumination target member such as a liquid crystal panel. For example, light diffusion plate 120 is formed of an optically transparent resin such as polymethylmethacrylate (PMMA), polycarbonate (PC), polystyrene (PS), and styrene methyl methacrylate copolymerization resin (MS). In order to provide a light diffusing property, minute irregularities are formed in the surface of light diffusion plate 120, or diffusing members such as beads are dispersed in light diffusion plate 120.

In surface light source device 100 according to the embodiment of the present invention, the light emitted from each light emitting element 220 is expanded by light flux controlling member 300 so as to illuminate a wide range of light diffusion plate 120. The light emitted from each light flux controlling member 300 is further diffused by light diffusion plate 120. Thus, surface light source device 100 according to the present invention can uniformly illuminate the irradiation target member (e.g., a liquid crystal panel).

### Configuration of Light Flux Controlling Member

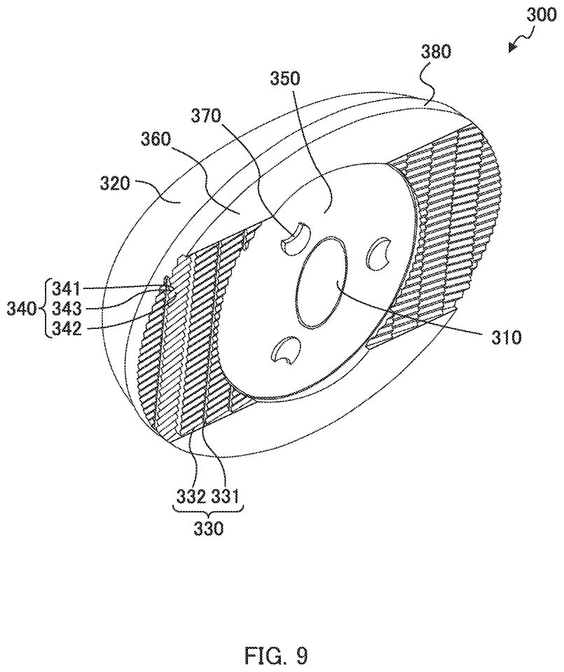

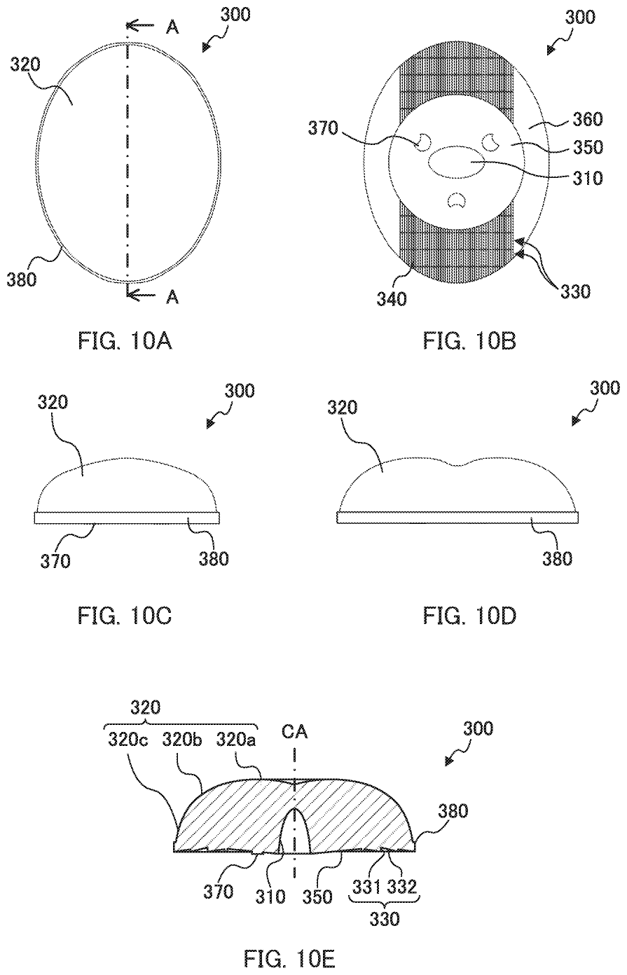

FIGS. 9 to 10E illustrate a configuration of light flux controlling member 300 according to Embodiment 1. FIG. 9 is a perspective view of light flux controlling member 300 as viewed from the rear side (substrate 210 side). FIG. 10A is a plan view of light flux controlling member 300, FIG. 10B is a bottom view light flux controlling member 300, FIG. 10C is a front view of light flux controlling member 300, FIG. 10D is a left side view of light flux controlling member 300, and FIG. 10E is a sectional view taken along line A-A of FIG. 10A. Note that, in the following description, substrate 210 side (light emitting element 220 side) is referred to as “rear side”, and light diffusion plate 120 side is referred to as “front side”.

As illustrated in FIGS. 9 to 10E, light flux controlling member 300 includes incidence surface 310, emission surface 320, a plurality of grooves 330, and a plurality of ridges 340. Light flux controlling member 300 according to the present embodiment further includes first rear surface 350, second rear surface 360, a plurality of legs 370, and flange 380.

Incidence surface 310 is an inner surface of a recess that is disposed at a center portion on the rear side in such a manner as to intersect central axis CA of light flux controlling member 300. The recess is disposed in such a manner as to intersect optical axis OA of light emitting element 220 (central axis CA of light flux controlling member 300). Incidence surface 310 allows the majority of light emitted from light emitting element 220 to enter flux controlling member 300 while controlling the travelling direction of the light. In a cross section perpendicular to central axis CA, incidence surface 310 may have an elliptical shape or a circular shape. In the present embodiment, incidence surface 310 has an elliptical shape in a cross section perpendicular to central axis CA. In addition, incidence surface 310 is a curved surface formed such that it comes closer to the rear side with increasing distance from central axis CA. Incidence surface 310 is rotationally symmetrical (2-fold rotational symmetrical) about central axis CA as the rotation axis. Note that, in the following description, the “cross section perpendicular to central axis CA” is also simply referred to as “horizontal cross section”.

First rear surface 350 is a surface that is located on the rear side of light flux controlling member 300, and extends from the opening edge of the recess composed of incidence surface 310 toward the outer edge of light flux controlling member 300. In the present embodiment, first rear surface 350 has a circular shape in plan view, and is a part of the rear side of light flux controlling member 300. First rear surface 350 may be a flat surface, or a curved surface. In the present embodiment, first rear surface 350 is an inclined surface formed such that it comes closer to the front side with increasing distance from central axis CA.

Second rear surface 360 is a surface that is located on the outside of first rear surface 350 on the rear side of light flux controlling member 300, and extends from the outer edge of first rear surface 350 to the outer edge of light flux controlling member 300. A step may be disposed between first rear surface 350 and second rear surface 360. In addition, second rear surface 360 may be a flat surface, or a curved surface. In the present embodiment, second rear surface 360 is a flat surface perpendicular to central axis CA. As described later, grooves 330 and ridges 340 are formed in a part of second rear surface 360.

Legs 370 form a gap for dissipating heat emitted from light emitting element 220 to the outside between substrate 210 and light flux controlling member 300, and positions light flux controlling member 300 with respect to substrate 210. In the present embodiment, three legs 370 are disposed on first rear surface 350. In addition, in the present embodiment, leg 370 has a partially cut columnar shape and a curved concave surface is formed in the surface of leg 370 on the side facing the radially outside of light flux controlling member 300. Thus, the light that reaches the curved concave surface through light flux controlling member 300 is emitted while being refracted and expanded.

Flange 380 protrude radially outward in such a manner as to surround the outer edge of light flux controlling member 300. Flange 380 connects between the outer edge of second rear surface 360 and the outer edge of emission surface 320.

Emission surface 320 is disposed in such a manner as to protrude from flange 380 on the front side (light diffusion plate 120 side) of light flux controlling member 300. Emission surface 320 emits the light having entered light flux controlling member 300 to the outside while controlling the travelling direction of the light. Emission surface 320 is disposed so as to intersect central axis CA. In the case where surface 310 has an elliptical shape in the horizontal cross section, emission surface 320 has an elliptical shape or a circular shape in the horizontal cross section. In addition, in the case where incidence surface 310 has a circular shape in the horizontal cross section, emission surface 320 has an elliptical shape in the horizontal cross section. That is, in the horizontal cross section, at least one of incidence surface 310 and emission surface 320 has an elliptical shape. In the present embodiment, in the horizontal cross section, both incidence surface 310 and emission surface 320 have an elliptical shape. In addition, in the present embodiment, the longitudinal axis of the ellipse of incidence surface 310 in the horizontal cross section is parallel to the minor axis of the ellipse of incidence surface 310 in the horizontal cross section.

Emission surface 320 includes first emission surface 320a located in a predetermined range around central axis CA, second emission surface 320b contiguous with the periphery of first emission surface 320a, and third emission surface 320c that connects between second emission surface 320b and flange 380 (see FIG. 10E). In the present embodiment, first emission surface 320a is a curved surface protruding toward the rear side. It should be noted that, in the case where emission surface 320 has an elliptical shape in the horizontal cross section, first emission surface 320a may not be a curved surface protruding rearward in the cross-section along the minor axis. The degree of the protrusion toward the rear side is adjusted in accordance with the arrangement (pitch) of light emitting devices 200 in the direction along the minor axis. Second emission surface 320b is a smooth curved surface protruding frontward and is located at the periphery of first emission surface 320a. Second emission surface 320b has an elliptical annular protruding shape. Third emission surface 320c is a curved surface located at the periphery of second emission surface 320b. As illustrated in FIG. 10C, in the cross section including central axis CA, the cross-sectional shape of third emission surface 320c may be a straight line or a curved line.

Grooves 330 are sequentially disposed from central axis CA side toward the outer edge of light flux controlling member 300 on the rear side of light flux controlling member 300. In the present embodiment, grooves 330 are each extend in a linear shape, and are disposed in a part of second rear surface 360 such that grooves 330 are parallel to each other. Each groove 330 extends along the longitudinal axis direction of the ellipse of incidence surface 310 in the horizontal cross section (the minor axis direction of the ellipse of emission surface 320 in the horizontal cross section). Here, “along the longitudinal axis direction” is a concept that encompasses not only the case where the valley line of groove 330 is parallel to the longitudinal axis, but also the case where the angle between the extension of the valley line and the extension of the longitudinal axis is 5° or smaller. Likewise, “along the minor axis direction” is a concept that encompasses not only the case where the valley line of groove 330 is parallel to the minor axis, but also the case where the angle between the extension of the valley line and the extension of the minor axis is 5° or smaller.

As described above, at least one of the horizontal cross section of incidence surface 310 and the horizontal cross section of emission surface 320 has an elliptical shape. Then, in the case where the horizontal cross section of incidence surface 310 has an elliptical shape, grooves 330 are disposed at least in the region outside the recess composed of incidence surface 310 in the minor axis direction of the ellipse on the rear side of light flux controlling member 300. The reason for this is that in the case where the horizontal cross section of incidence surface 310 has an elliptical shape, reflection light from emission surface 320 tends to reach this region. In addition, in the case where the horizontal cross section of emission surface 320 has an elliptical shape, grooves 330 are disposed at least in a region outside the recess in the longitudinal axis direction of the ellipse on the rear side of light flux controlling member 300. The reason for this is that in the case where the horizontal cross section of emission surface 320 has an elliptical shape, reflection light from emission surface 320 tends to reach this region. In the present embodiment, in the horizontal cross section, both incidence surface 310 and emission surface 320 have an elliptical shape. Grooves 330 are disposed in a part of second rear surface 360 located outside the recess in the minor axis direction of the ellipse of the horizontal cross section of incidence surface 310 and in the longitudinal axis direction of the ellipse of the horizontal cross section of emission surface 320.

Each groove 330 includes step surface 331 located on central axis CA side and inclined surface 332 located on the outer edge side. Inclined surface 332 is inclined such that it comes closer to the rear side as it comes closer to the outer edge of light flux controlling member 300 from central axis CA side, and inclined surface 332 reflects, toward the radially outside of light flux controlling member 300, the reflection light from emission surface 320. As described later, inclined surface 332 is provided with ridge 340, which is a reflection structure for efficiently reflecting light. The inclination angles of the inclined surfaces 332 of different grooves 330 may be different from each other or may be identical to each other. In the present embodiment, the inclination angles of inclined surfaces 332 are different from each other. By providing step surface 331 between two inclined surfaces 332 adjacent to each other, or in other words, by providing a plurality of grooves 330 rather than one groove 330, the depth of groove 330 can be set to a small value while disposing inclined surface 332 having an inclination angle of a predetermined value or greater in a relatively wide region on the rear side of light flux controlling member 300. Step surface 331 may be parallel to central axis CA, or may be inclined to central axis CA. In the present embodiment, step surface 331 is parallel to central axis CA.

Ridges 340 are formed in inclined surface 332 of each groove 330. Ridge 340 reflects, toward the radially outside of light flux controlling member 300, the reflection light from emission surface 320. Each ridge 340 includes first reflection surface 341, second reflection surface 342, and ridgeline 343 disposed therebetween. Examples of the cross-sectional shape of ridge 340 in the direction perpendicular to ridgeline 343 include a triangular shape, a triangular shape with a chamfered apex, a semicircular shape, a trapezoidal shape with another surface between first reflection surface 341 and second reflection surface 342, and the like. In the present embodiment, the cross-sectional shape of ridge 340 in the direction perpendicular to ridgeline 343 is a triangular shape. Specifically, in the present embodiment, first reflection surface 341 and second reflection surface 342 are connected with each other by ridgeline 343. Each ridge 340 functions as a total reflection prism. In addition, in plan view, ridges 340 are parallel to each other along the minor axis direction of the ellipse of the horizontal cross section of incidence surface 310 (the longitudinal axis direction of the ellipse of the horizontal cross section of emission surface 320). Here, “along the minor axis direction” is a concept that encompasses not only the case where ridgeline 343 of ridge 340 is parallel to the minor axis, but also the case where the angle between the extension of ridgeline 343 and the extension of the minor axis is 5° or smaller in plan view. Likewise, “along the longitudinal axis direction” is a concept that encompasses not only the case where ridgeline 343 of ridge 340 is parallel to the longitudinal axis, but also the case where the angle ridgeline 343 of ridge 340 and the extension of the longitudinal axis is 5° or smaller.

As described above, at least one of the horizontal cross section of incidence surface 310 and the horizontal cross section of emission surface 320 has an elliptical shape. In the case where the horizontal cross section of incidence surface 310 has an elliptical shape, ridges 340 are disposed at least in the region outside the recess composed of incidence surface 310 in the minor axis direction of the ellipse on the rear side of light flux controlling member 300. The reason for this is that in the case where the horizontal cross section of incidence surface 310 has an elliptical shape, reflection light from emission surface 320 tends to reach this region. In addition, in the case where the horizontal cross section of emission surface 320 has an elliptical shape, ridges 340 are disposed at least in a region outside the recess in the longitudinal axis direction of the ellipse on the rear side of light flux controlling member 300. The reason for this is that in the case where the horizontal cross section of emission surface 320 has an elliptical shape, reflection light from emission surface 320 tends to reach this region. In the present embodiment, in the horizontal cross section, both incidence surface 310 and emission surface 320 have an elliptical shape. Ridges 340 are disposed in a part of second rear surface 360 (more specifically, inclined surface 332) located outside the recess in the minor axis direction of the ellipse of the horizontal cross section of incidence surface 310, and in the longitudinal axis direction of the ellipse of the horizontal cross section of emission surface 320.

### Simulation of Light Distribution Characteristics of Light Flux Controlling Member

A simulation about light paths in light flux controlling member 300 according to the present embodiment was performed. In addition, for comparison, the same simulation was performed with comparative light flux controlling member 300c that has the same shape as that of the light flux controlling member 300 except that the plurality of grooves 330 and the plurality of ridges 340 are not provided (second rear surface 360 is a flat surface in its entirety).

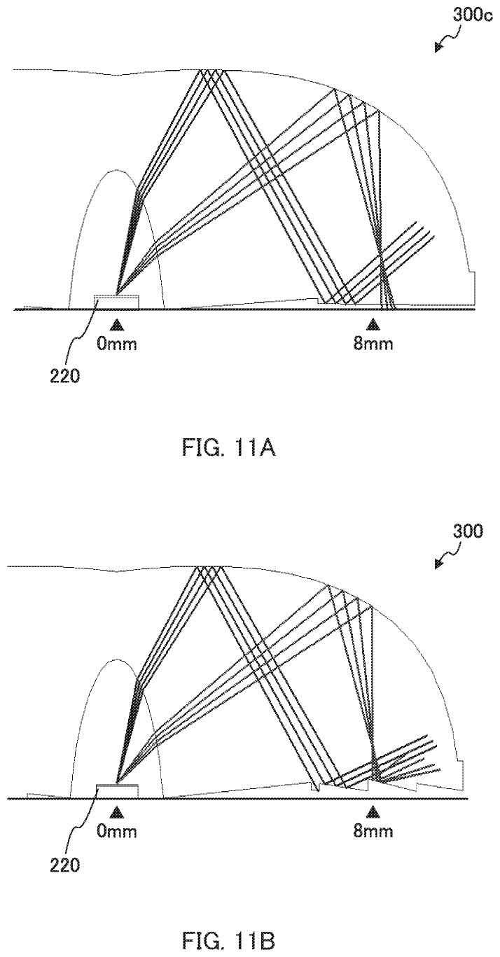

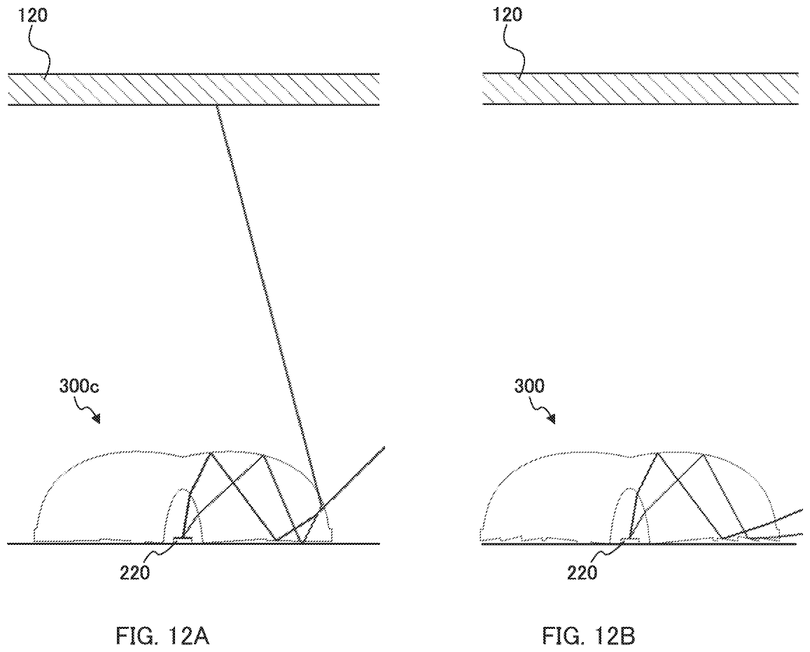

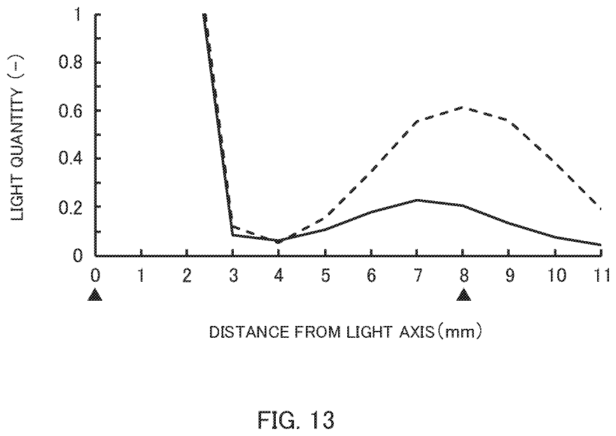

FIG. 11A is a sectional view illustrating light paths in comparative light flux controlling member 300c, and FIG. 11B is a sectional view illustrating light paths in light flux controlling member 300 according to the present embodiment. In addition, FIG. 12A is a sectional view illustrating light paths in comparative light flux controlling member 300c (in a wider range than FIG. 11A), and FIG. 12B is a sectional view illustrating light paths in light flux controlling member 300 according to the present embodiment (in a wider range than FIG. 11B). These drawings include cross-sections along the longitudinal axis direction of the ellipse of the horizontal cross section of emission surface 320 (the minor axis direction of the ellipse of the horizontal cross section of incidence surface 310). FIG. 13 is a graph showing the quantity of light that reaches substrate 210 through the rear surface of light flux controlling members 300 and 300c, as relative values with respect to 1 set as the maximum value. In the graph of FIG. 13, the solid line indicates the light quantity of the case where light flux controlling member 300 according to the present embodiment is used, and the broken line indicates the light quantity of the case where comparative light flux controlling member 300c is used. In addition, in the sectional view of FIGS. 11A and 11B, the positions of 0 mm and 8 mm on the abscissa in the graph of FIG. 13 are indicated as black triangles.

As illustrated in FIG. 11A, in comparative light flux controlling member 330c, a part of light reflected by emission surface 320 passes through second rear surface 360 since the incident angle with respect to second rear surface 360 is small. As illustrated in FIG. 12A, the above-mentioned light having passed through second rear surface 360 is reflected by substrate 210, and reenters light flux controlling member 330c from second rear surface 360 so as to be emitted from emission surface 320 at a small angle with respect to optical axis OA of light emitting element 220. The light emitted upward from light flux controlling member 330c in the above-mentioned manner may generate bright spots on light diffusion plate 120 (light emitting surface).

On the other hand, as illustrated in FIG. 11B, in light flux controlling member 300 according to the present embodiment, the majority of the light reflected by emission surface 320 is reflected by inclined surface 332 (first reflection surface 341 or second reflection surface 342) toward the radially outside of light flux controlling member 300 since the incident angle with respect to inclined surface 332 (first reflection surface 341 or second reflection surface 342 of ridge 340) is large. The graph of FIG. 13 also shows that the majority of the light reflected by emission surface 320 is reflected by inclined surface 332. The light that has been reflected by inclined surface 332 in the above-mentioned manner is emitted from emission surface 320 at a large angle with respect to optical axis OA of light emitting element 220 as illustrated in FIG. 12B. In the above-mentioned manner, in light flux controlling member 300 according to the present embodiment, the majority of the light reflected by emission surface 320 is emitted in the lateral direction from the light flux controlling member 330, and thus the luminance unevenness at light diffusion plate 120 (light emitting surface) due to the light reflected by emission surface 320 is less caused.

### Effect

As described above, in light flux controlling member 300 according to the present embodiment, a plurality of inclined surfaces 332 are formed on the rear side of light flux controlling member 300, and ridges 340 are formed in inclined surfaces 332. Thus, in surface light source device 100 according to the present embodiment, the majority of the light internally reflected by the emission surface 320 is emitted from emission surface 320 at a large angle with respect to optical axis OA of light emitting element 220, and the luminance unevenness at light diffusion plate 120 (light emitting surface) due to the light reflected by emission surface 320 is less caused.

In addition, in light flux controlling member 300 according to the present embodiment, a plurality of divided inclined surfaces 332 are provided instead of one large inclined surface on the rear side of light flux controlling member 300, and therefore the height of the upper end (the portion on the most front side) of each inclined surface 332 is small (the distance from the substrate 210 is small). Accordingly, the light emitted from light emitting element 220 in the lateral direction is less likely to reach step surface 331 of groove 330. Therefore, surface light source device 100 according to the present embodiment is less likely to cause the luminance unevenness at light diffusion plate 120 (light emitting surface) due to the light that reaches step surface 331 of groove 330 after emission in the lateral direction from light emitting element 220.

### Embodiment 2

A surface light source device according to Embodiment 2 differs from surface light source device 100 according to Embodiment 1 only in configuration of light flux controlling member 400. In view of this, light flux controlling member 400 is mainly described in the present embodiment. Note that the components similar to those of surface light source device 100 are denoted with the same reference numerals and the description thereof will be omitted.

### Configuration of Light Flux Controlling Member

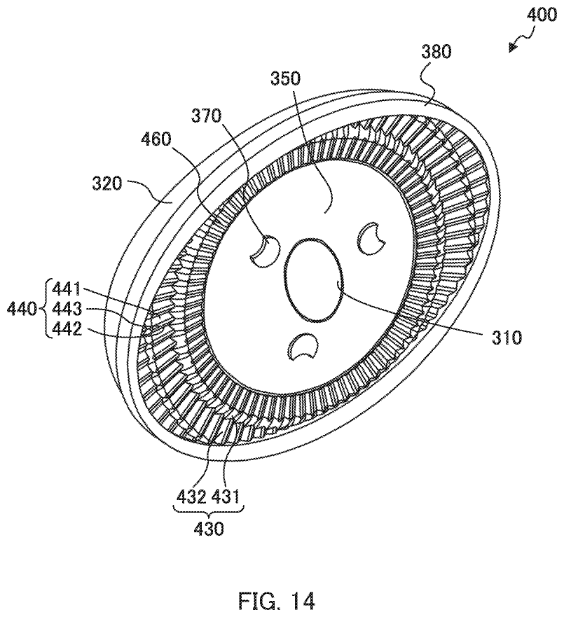

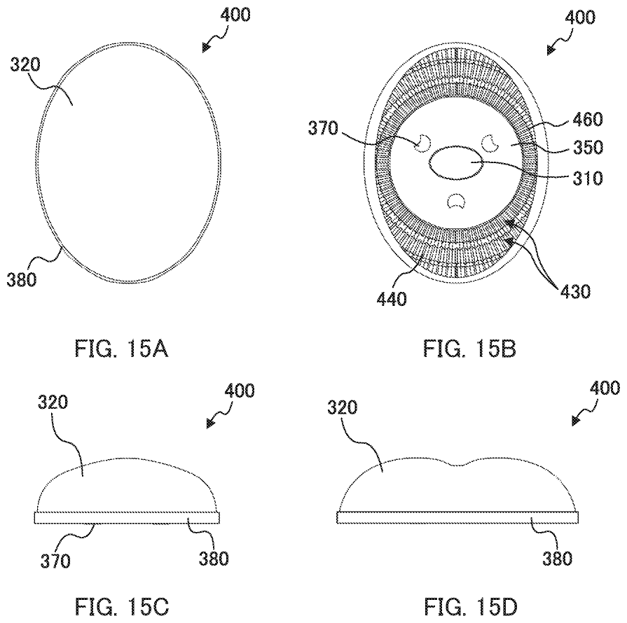

FIGS. 14 to 15D illustrate a configuration of light flux controlling member 400 according to Embodiment 2. FIG. 14 is a perspective view of light flux controlling member 400 as viewed from the rear side (substrate 210 side). FIG. 15A is a plan view of light flux controlling member 400, FIG. 15B is a bottom view of light flux controlling member 400, FIG. 15C is a front view of light flux controlling member 400, and FIG. 15D is a left side view of light flux controlling member 400.

As illustrated in FIGS. 14 to 15D, light flux controlling member 400 includes incidence surface 310, emission surface 320, a plurality of grooves 430, and a plurality of ridges 440. Light flux controlling member 400 according to the present embodiment further includes first rear surface 350, second rear surface 460, a plurality of legs 370, and flange 380.

Second rear surface 460 is a surface that is located outside first rear surface 350 on the rear side of light flux controlling member 400, and extends from the outer edge of first rear surface 350 to the outer edge of light flux controlling member 400. A step may be disposed between first rear surface 350 and second rear surface 360. As described later, in the present embodiment, grooves 430 are formed in the entirety of second rear surface 460.

Grooves 430 are sequentially disposed on the rear side of light flux controlling member 400 from central axis CA side to the outer edge side of light flux controlling member 400. In the present embodiment, grooves 430 are concentrically disposed around central axis CA in the entirety of second rear surface 460.

Each groove 430 includes step surface 431 located on central axis CA side and inclined surface 432 located on the outer edge side. Inclined surface 432 is inclined such that it comes closer to the rear side in the direction from central axis CA side toward the outer edge of light flux controlling member 400, and reflects, toward the radially outside of light flux controlling member 400, the reflection light from emission surface 420. As described later, inclined surface 432 is provided with ridge 440, which is a reflection structure for efficiently reflecting light. The inclination angles of inclined surfaces 432 of different grooves 430 may be identical to each other or different from each other. In the present embodiment, the inclination angles of inclined surfaces 432 are different from each other. By providing step surface 431 between two inclined surfaces 432 adjacent to each other, or in other words, by disposing a plurality of grooves 430 rather than one groove 430, the depth of groove 430 can be set to a small value while disposing inclined surface 432 having an inclination angle of a predetermined value or greater in a relatively wide region on the rear side of light flux controlling member 400. Step surface 431 may be parallel to central axis CA, or may be inclined to central axis CA. In the present embodiment, step surface 431 is tilted such that it comes closer to central axis CA in the direction toward the rear side.

Ridges 440 are disposed in inclined surface 432 of each groove 430. Ridge 440 reflects, toward the radially outside of light flux controlling member 400, the reflection light from emission surface 420. Each ridge 440 includes first reflection surface 441, second reflection surface 442, and ridgeline 443 disposed therebetween. Examples of the cross-sectional shape of ridge 440 in the direction perpendicular to ridgeline 443 include a triangular shape, a triangular shape with a chamfered apex, a semicircular shape, a trapezoidal shape with another surface between first reflection surface 441 and second reflection surface 442 and the like. In the present embodiment, the cross-sectional shape of ridge 440 in the direction perpendicular to ridgeline 443 is a triangular shape with a chamfered apex. Each ridge 440 functions as a total reflection prism. In addition, ridges 440 are radially disposed around central axis CA in plan view. Here “ridges 440 are radially disposed around central axis CA in plan view” means that ridges 440 are disposed such that the extensions of ridgelines 443 intersect central axis CA.

### Effect

In light flux controlling member 400 according to the present embodiment, grooves 430 (ridges 440) are formed in the entirety of second rear surface 460. Thus, the surface light source device according to the present embodiment less likely causes the luminance unevenness at light diffusion plate 120 (light emitting surface) due to the light reflected by emission surface 320.

Note that, while incidence surface 310 and emission surface 320 have elliptical shapes in the horizontal cross section in Embodiments 1 and 2, it is also possible to adopt a configuration in which incidence surface 310 has an elliptical shape in the horizontal cross section and emission surface 320 has a circular shape in the horizontal cross section. Further, it is also possible to adopt a configuration in which incidence surface 310 has a circular shape in the horizontal cross section and emission surface 320 has a circular shape in the horizontal cross section.

This application is entitled to and claims the benefit of Japanese Patent Application No. 2017-212787 filed on Nov. 2, 2017, the disclosure each of which including the specification, drawings and abstract is incorporated herein by reference in its entirety.

### INDUSTRIAL APPLICABILITY

The light flux controlling member, the light emitting device and the surface light source device of the embodiments of the present invention are applicable to, for example, a backlight of a liquid crystal display device or a generally-used illumination device.

### REFERENCE SIGNS LIST

10 Light emitting element
20, 30 Light flux controlling member
22 Incidence surface
24 Emission surface
26 Rear surface
32 Inclined surface
34 Perpendicular surface
100 Surface light source device
107 Display member
110 Housing
112 Bottom plate
114 Top plate
120 Light diffusion plate
200 Light emitting device
210 Substrate
220 Light emitting element
300, 400 Light flux controlling member
310 Incidence surface
320 Emission surface
320a First emission surface
320b Second emission surface
320c Third emission surface
330, 430 Groove
331, 431 Step surface
332, 432 Inclined surface
340, 440 Ridge
341, 441 First reflection surface
342, 442 Second reflection surface
343, 443 Ridgeline
350 First rear surface
360, 460 Second rear surface
370 Leg
380 Flange
CA Central axis of light flux controlling member
OA Optical axis of light emitting element

1. A light flux controlling member configured to control a distribution of light emitted from a light emitting element, the light flux controlling member comprising:
an incidence surface that is an inner surface of a recess disposed on a rear side of the light flux controlling member, the recess being disposed to intersect a central axis of the light flux controlling member, the incidence surface being configured to allow incidence of the light emitted from the light emitting element;
an emission surface disposed on a front side of the light flux controlling member to intersect the central axis, the emission surface being configured to emit, to outside, light entered from the incidence surface;
a plurality of grooves sequentially disposed in a direction toward an outer edge side of the light flux controlling member from a central axis side on the rear side of the light flux controlling member, each of the plurality of grooves including a step surface located on the central axis side and an inclined surface located on the outer edge side; and
a plurality of ridges disposed in the inclined surface of each of the plurality of grooves, each of the plurality of ridges including a first reflection surface, a second reflection surface, and a ridgeline disposed between the first reflection surface and the second reflection surface,
wherein at least one of the incidence surface and the emission surface has a shape of an ellipse in a cross-section perpendicular to the central axis,
wherein when the incidence surface has the shape of the ellipse in the cross-section, at least one of the plurality of ridges is disposed in the inclined surface located outside the recess in a direction of a minor axis of the ellipse, and
wherein when the emission surface has the shape of the ellipse in the cross-section, at least one of the plurality of ridges is disposed in the inclined surface located outside the recess in a direction of a longitudinal axis of the ellipse.

2. The light flux controlling member according to claim 1,
wherein each of the incidence surface and the emission surface has the shape of the ellipse in the cross-section; and
wherein a longitudinal axis of the ellipse of the incidence surface in the cross-section is parallel to a minor axis of the ellipse of the emission surface in the cross-section.

3. The light flux controlling member according to claim 2,
wherein the plurality of grooves are disposed on the rear side of the light flux controlling member in a region located outside the recess in the direction of the minor axis of the ellipse of the incidence surface in the cross-section, the plurality of grooves being parallel to each other along a direction of the longitudinal axis of the ellipse of the incidence surface in the cross-section; and
wherein in plan view, the plurality of ridges are parallel to each other along the direction of the minor axis of the ellipse of the incidence surface in the cross-section.

4. The light flux controlling member according to claim 1,
wherein the plurality of grooves are concentrically disposed around the central axis; and
wherein the plurality of ridges are radially disposed in plan view.

5. A light emitting device comprising:
a light emitting element; and
the light flux controlling member according to claim 1, the light flux controlling member being disposed over the light emitting element.

6. A surface light source device comprising:
the light emitting device according to claim 5; and
a light diffusion plate configured to allow light emitted from the light emitting device to pass through the light diffusion plate while diffusing the light.

7. A display device comprising:
the surface light source device according to claim 6; and
a display member configured to be irradiated with light emitted from the surface light source device.
